(19) United States
(12) Patent Application Publication
(10) Pub. No.: US 2011/0281153 A1
(43) Pub. Date: Nov. 17, 2011

(54) BATTERY

(75) Inventors: Yihsong Jan, Taipei City (TW); Lun-Chieh Ho, Taichung City (TW)

(73) Assignee: EXA ENERGY TECHNOLOGY CO., LTD., TAICHUNG CITY (TW)

(21) Appl. No.: 12/779,795

(22) Filed: May 13, 2010

(51) Int. Cl. H01M 2/00

(52) U.S. Cl. 429/163

(57) ABSTRACT

A battery includes at least one positive pole film, at least one negative pole film, at least one isolation membrane, a positive pole clamp, a negative pole clamp, a positive conducting pole, a negative conducting pole, a shell and an electrolyte. The positive pole film includes a positive pole material film and a bare aluminum zone, and the negative pole film includes a negative pole material film and a bare copper zone. The negative pole material film overlaps the positive pole material film, and the isolation membrane is disposed between the pole films to isolate the negative pole material film from the positive pole material film. The positive pole clamp clamps the bare aluminum zone, and the negative pole clamp clamps the bare copper zone. The positive conducting pole is welded to the positive pole clamp, and the negative conducting pole is welded to the negative pole clamp.

### BACKGROUND OF THE INVENTION

1. Field of the Invention

The present invention relates to a battery, and more particularly to a battery includes multi-layers of positive and negative pole films.

2. Description of the Prior Art

Some battery includes multi-layers of positive and negative pole films overlapping each other. The positive pole film has a bare aluminum zone, and the negative pole film has a bare copper zone. The bare aluminum/copper zones are welded by conducting poles directly to work as a battery.

It is noted that the bare aluminum/copper zones are thin, which means they are fragile in structure. As such, they can be broken as the conducting pole is welded thereto. As a result, the battery may have a short circuit or a broken circuit.

The present invention is, therefore, arisen to obviate or at least mitigate the above mentioned disadvantages.

SUMMARY OF THE INVENTION

The main object of the present invention is to provide a battery whose bare aluminum/copper zones are clamped by pole clamps, which are then welded by conducting poles.

To achieve the above and other objects, the battery of the present invention includes at least one positive pole film, at least one negative pole film, at least one isolation membrane, a positive pole clamp, a negative pole clamp, a positive conducting pole, a negative conducting pole, a shell and an electrolyte. The positive pole film includes a positive pole material film and a bare aluminum zone. The bare aluminum zone is extended from one side of the positive pole material film. The negative pole film includes a negative pole material film and a bare copper zone. The bare copper zone is extended from one side of the negative pole material film. The negative pole material film overlaps the positive pole material film. The isolation membrane is disposed between the positive pole film and the negative pole film to isolate the positive pole material film from the negative pole material film. The isolation membrane has a first side and a second side opposite to the first side. The bare aluminum zone is protrusive from the first side of the isolation membrane, and the bare copper zone is protrusive from the second side of the isolation membrane. The positive pole clamp clamps at least a part of the bare aluminum zone of the positive pole film, and the negative pole clamp clamps at least a part of the bare copper zone of the negative pole film. The positive conducting pole is welded to the positive pole clamp, and the negative conducting pole is welded to the negative pole clamp. The shell accommodates the pole films, the isolation membrane, the pole clamps and the conducting poles therein. The electrolyte is filled in the shell.

Thereby, the bare aluminum/copper zones are protected from breaking during the welding process. Thus further short circuits or broken circuits are prohibited.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a battery of the present invention;

FIG. 2 is a breakdown drawing showing pole films and isolation membranes of the present invention;

FIG. 3 is a side view showing a battery of the present invention;

FIG. 4 is a side view showing another battery of the present invention;

FIG. 5 is a breakdown drawing showing yet another battery of the present invention.

### DETAILED DESCRIPTION OF THE PREFERRED EMBODIMENTS

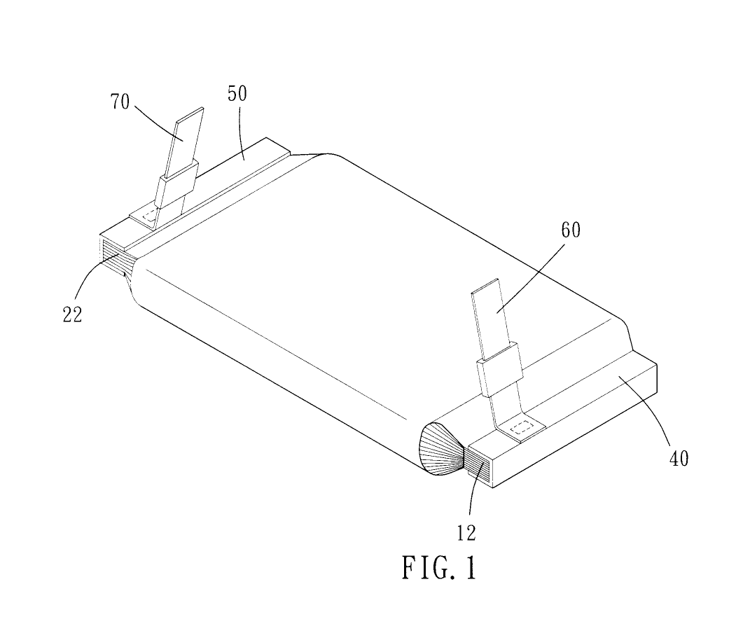

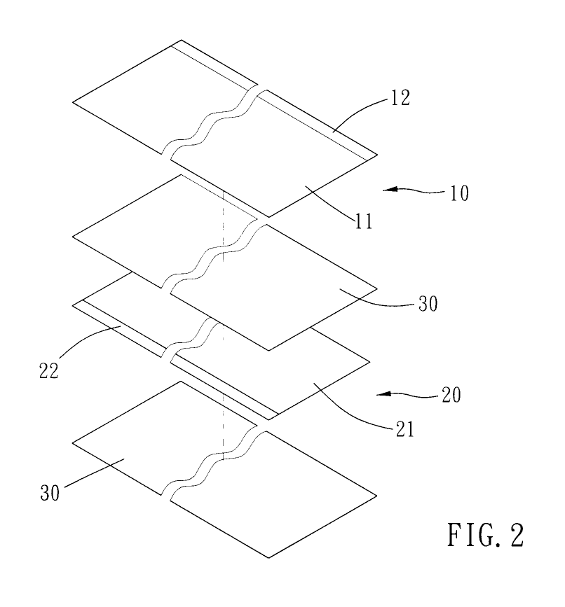

Please refer to FIG. 1 and FIG. 2. A battery of the present invention includes at least one positive pole film 10, at least one negative pole film 20, at least one isolation membrane 30, a positive pole clamp 40, a negative pole clamp 50, a positive conducting pole 60, a negative conducting pole 70, a shell (not shown) accommodating the above components, and an electrolyte filled in the shell.

The positive pole film 10 includes a positive pole material film 11 and a bare aluminum zone 12, which is extended from one side of the positive pole material film 11. The positive pole material film 11 can be LiCoO₂, LiMn₂O₂, LiNiO₄, LiCoₓNi₁₋ₓO₂ or the like. Alternatively, the positive pole material film 11 may be made of any of the variety of other materials such as lithiated oxide, lithiated sulfide, lithiated selenide, lithiated telluride, lithium-iron-phosphorus oxide, lithium-vanadium-phosphorus oxide of vanadium, titanium, chromium, copper, molybdenum, niobium, iron, nickel, cobalt, manganese or a mixture thereof. Preferably, the positive pole film 10 includes an aluminum strip, and a positive pole material is coated on a part of the aluminum strip to form the positive pole material film 11. The rest uncoated surface of the aluminum strip is the bare aluminum zone 12.

The negative pole film 20 includes a negative pole material film 21 and a bare copper zone 22 extended from one side of the negative pole material film 21. The negative pole material film 22 can be made of Mesophase Carbon Micro Beads (MCMB), Vapor-Grown Carbon Fiber (VGCF), Carbon Nanotube (CNT), coke, carbon black, graphite, acetylene black, carbon fiber, vitreous carbon or a mixture thereof. Preferably, the negative pole film 20 includes a copper strip, and a negative pole material is coated on a part of the copper strip to form the positive pole material film 21. The rest uncoated surface of the copper strip is the bare copper zone 22.

The negative pole material film 22 overlaps the positive pole material film 12, and the pole material films 12 and 22 are isolated from each other by the isolation membrane 30. The isolation membrane 30 has a first side and a second side opposite to the first side. The bare aluminum zone 12 is protrusive from the first side, and the bare copper zone 22 is protrusive form the second side. The isolation membrane 30 is made of for example, polypropylene or polyethylene.

The pole clamps 40 and 50 have an n-shaped profile to clamp at least a part of the bare aluminum zone 12 and bare copper zone 22 respectively. The positive pole clamp 40 is preferably made of aluminum, and the negative pole clamp 50 is preferably made of copper. As such, the pole clamps 40 and 50 electrically connect to the bare aluminum zone 12 and bare copper zone 22 respectively.

The conducting poles 60 and 70 are welded to the pole clamps 40 and 50 respectively, so as to electrically connect to the pole films 10 and 20. Distal ends of the conducting poles 60 and 70 preferably extend to the both ends of the shell to form the positive pole contact and negative pole contact of the battery respectively.

The welding material for the positive conducting pole 60 can be made of aluminum, and the welding material for the negative conducting pole 70 can be made of copper.

More specifically, the positive pole clamp 40 has a positive clamp outer surface and a positive clamp inner surface, and the negative pole clamp 50 has a negative clamp outer surface and a negative clamp inner surface. The positive clamp inner surface faces the bare aluminum zone 12, while the negative clamp inner surface faces the bare copper zone 22.

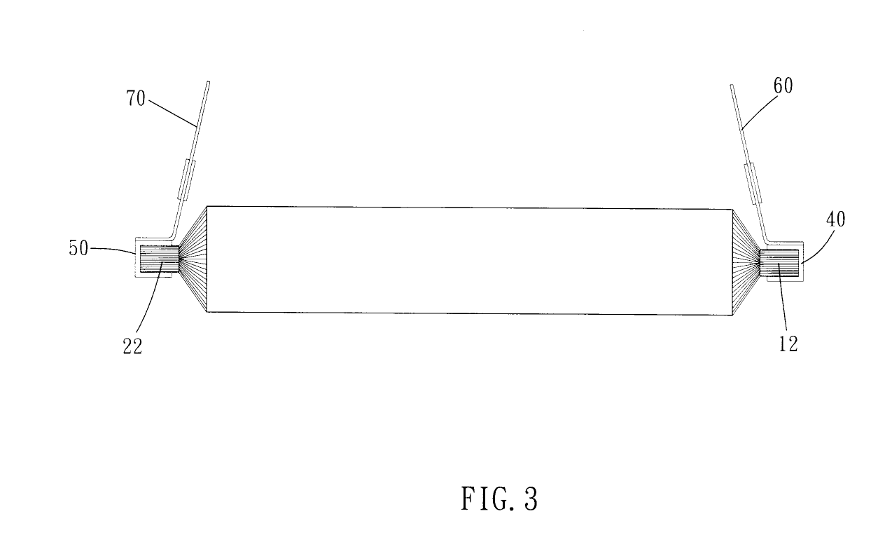

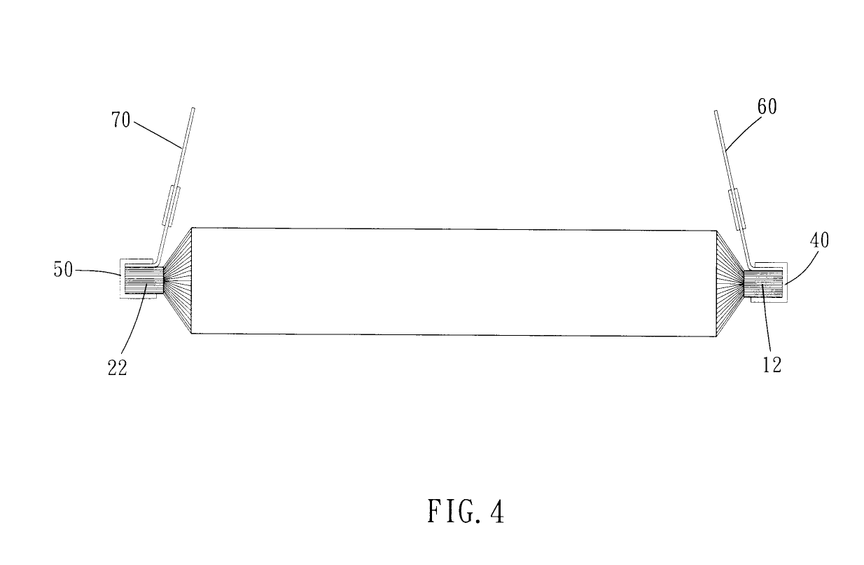

In the embodiment shown in FIG. 1 and FIG. 3, the positive conducting pole 60 is welded to the positive clamp outer surface, and the negative conducting pole 70 is welded to the negative clamp outer surface. In the embodiment shown in FIG. 4, the positive conducting pole 60 is welded between the positive clamp inner surface and the bare aluminum zone 12, and the negative conducting pole 70 is welded between the negative clamp inner surface and the bare copper zone 22.

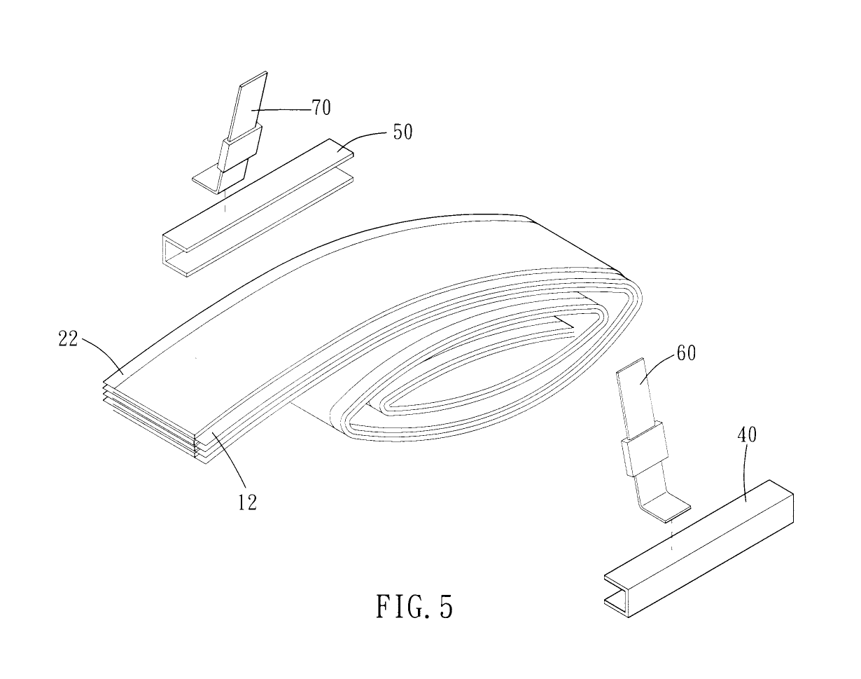

In the present invention, the pole films 10, 20 and isolation membrane 30 can be arranged as shown in FIG. 1 and FIG. 2 to be flat. Or, they can also be rolled up in a roll as shown in FIG. 5. A further core (not shown) can be provided for the pole films 10, 20 and isolation membrane 30 to dispose thereabout.

Thereby, the bare aluminum zone and the bare copper zone are strengthened by the pole clamps, thus they are less fragile and will not easily break during the welding process. As a result, the disadvantages of short circuits and broken circuits can be, therefore, prohibited.

What is claimed is:

1. A battery, comprising:
at least one positive pole film, comprising a positive pole material film and a bare aluminum zone, the bare aluminum zone being extended from one side of the positive pole material film;
at least one negative pole film, comprising a negative pole material film and a bare copper zone, the bare copper zone being extended from one side of the negative pole material film, the negative pole material film overlapping the positive pole material film;
at least one isolation membrane, disposed between the positive pole film and the negative pole film to isolate the positive pole material film from the negative pole material film, the isolation membrane having a first side and a second side opposite to the first side, the bare aluminum zone being protrusive from the first side of the isolation membrane, and the bare copper zone being protrusive from the second side of the isolation membrane;
a positive pole clamp, clamping at least a part of the bare aluminum zone of the positive pole film;
a negative pole clamp, clamping at least a part of the bare copper zone of the negative pole film;
a positive conducting pole, welded to the positive pole clamp;
a negative conducting pole, welded to the negative pole clamp;
a shell, accommodating the positive pole film, the negative pole film, the isolation membrane, the positive pole clamp, the negative pole clamp, the positive conducting pole and the negative conducting pole therein;
an electrolyte, filled in the shell.

2. The battery of claim 1, wherein the positive pole clamp has a positive clamp outer surface and a positive clamp inner surface, the negative pole clamp has a negative clamp outer surface and a negative clamp inner surface, the positive clamp inner surface faces the bare aluminum zone of the positive pole film, the negative clamp inner surface faces the bare copper zone of the negative pole film, the positive conducting pole is welded to the positive clamp outer surface, the negative conducting pole is welded to the negative clamp outer surface.

3. The battery of claim 1, wherein the positive pole clamp has a positive clamp outer surface and a positive clamp inner surface, the negative pole clamp has a negative clamp outer surface and a negative clamp inner surface, the positive clamp inner surface faces the bare aluminum zone of the positive pole film, the negative clamp inner surface faces the bare copper zone of the negative pole film, the positive conducting pole is welded between the positive clamp inner surface and the bare aluminum zone, the negative conducting pole is welded between the negative clamp inner surface and the bare copper zone.

4. The battery of claim 1, wherein the positive pole film, the negative pole film and the isolation membrane are rolled up in a roll.

5. The battery of claim 4, wherein the positive pole film, the negative pole film and the isolation membrane are disposed about a core.

6. The battery of claim 1, wherein the positive pole film, the negative pole film and the isolation membrane are flat.
